(19) United States
(12) Patent Application Publication
(10) Pub. No.: US 2005/0053759 A1
(43) Pub. Date: Mar. 10, 2005

(54) Controlled air permeability composite fabric articles having enhanced surface durability

(75) Inventors: Moshe Rock, Brookline, MA (US); Douglas Lumb, Atkinson, NH (US); Charles Haryslak, Marlborough, MA (US); Gadalia Vainer, Melrose, MA (US)

Correspondence Address: FISH & RICHARDSON PC, 225 FRANKLIN ST, BOSTON, MA, 02110, US

(73) Assignee: Malden Mills Industries, Inc., Lawrence, MA (US)

(21) Appl. No.: 10/911,855

(22) Filed: Aug. 5, 2004

Related U.S. Application Data
(60) Provisional application No. 60/493,275, filed on Aug. 7, 2003.

(51) Int. Cl. B32B 27/04; B32B 3/02; D04B 9/00; B32B 27/12; D04H 11/00

(52) U.S. Cl. 428/91; 428/96; 442/181; 442/304; 442/301; 428/195.1; 428/196; 428/197

(57) ABSTRACT

A fabric article of knitted or woven construction with multi-filament, interlaced yarns has a pile or raised or fleece region on its inner surface and a discontinuous coating of binder material on its outer surface. The binder material provides improved durability against pilling and fraying without substantial adverse effect on characteristics of the base fabric. A method of forming the fabric article is also described.

This application claims benefit from U.S. Provisional Patent Application No. 60/493,275, filed Aug. 7, 2003.

### TECHNICAL FIELD

The invention relates to composite fabric articles, and more particularly to composite fabric articles having improved surface durability, in particular without substantial adverse affect on desirable qualities of the fabric, e.g. such as drapability, moisture vapor transport (MVT), hand tactile, etc.

### BACKGROUND

Fabric articles, Such as jackets and other outer wear, with qualities desired for use during exercise or exertion, especially warmth and breathability, may be formed, e.g., by circular knit plaited construction or circular knit reverse plaited construction, may be formed with a relatively smooth outer surface (the “technical face”) and an inner surface (the “technical back”) that can be raised, e.g. by processes such as napping, brushing, sanding, etc., to form an insulating layer of fleece. Unfortunately, in both knit constructions, the durability of the smooth technical face is inferior to many woven constructions, limiting their use in articles intended for harsher outdoor sports. In particular, the fuzziness of the smooth technical face will often have an inferior aesthetic look, as well as poor technical features. The smooth face also tends to fuzz out as the surface picks up snow, which it will not shed easily, to fuzz out during rock climbing, and to fuzz out in specific areas of a garment, e.g. at the elbows or at the shoulders, under the straps of a backpack.

Composite fabric articles are achieved by joining at least one material to a fabric body to attain desirable properties that cannot be attained by the fabric body alone. Laminar composites, for example, having multiple layers joined by an adhesive are sometimes employed to increase the thermal resistance of a fabric body. However, the feel (e.g., drapability, hand tactile, etc.) is often substantially decreased by laminating one or more additional layers of material to the fabric body.

### SUMMARY

According to one aspect of the invention, a fabric article with knitted or woven construction of multi-filament, interlaced yarns has an inner surface and an outer surface. The inner surface has at least one region of pile or raised fibers or fleece formed thereupon and the outer surface has a non-continuous coating of binder material adhered to yarns and to yarn fibers at least at interlacing intersections, for enhanced durability of the outer surface against pilling or fraying during use.

Preferred embodiments of this aspect of the invention may include one or more of the following additional features. The fabric article has a plaited circular knit construction, reverse plaited circular knit construction, woven construction or warp knit construction. The fabric article is an article of wearing apparel. The multi-filament yarns are textured or flat. The multi-filament yarns comprise fibers formed of materials selected from the group consisting of: polyester, nylon and polypropylene. The multi-filament yarns of the outer surface comprise spandex. Fibers of the multi-filament yarns are highly intermingled at over about 60 tucks per meter (TPM) and preferably at over about 100 TPM or more, or there may be little or no intermingling. The binder material adheres only to yarn fibers in a manner to substantially avoid restriction of air permeability through the fabric article. Alternatively, the binder material comprises a film extending into interstitial air passageways through the fabric article in a manner to reduce air permeability. The non-continuous coating of binder material is without substantial adverse effect on drapability and hand of the fabric article. The fabric article has one or more first regions of enhanced surface durability due to relatively greater density of binder or binder dots per unit area applied by engineered pattern printing technology to a fabric web. Preferably the one or more first regions comprise shoulder regions. The fabric article has one or more second regions of relatively lesser surface durability due to relatively lesser density of binder or binder dots per unit area applied by engineered pattern printing technology to a fabric web. Preferably, the one or more second regions comprise body regions.

According to another aspect of the invention, a method of forming a fabric article comprises the steps of: interlacing yarns comprising multi-filament fibers to form a fabric body of knit or woven construction, forming a raised or fleece region upon an inner surface of the fabric body; and, thereafter, applying a binder material to at least the outer surface to form a discontinuous coating of binder material upon at least yarn fibers at interlacing intersections on at least the outer surface of the fabric article, to resist pilling and fraying of yarn fibers at the outer surface.

Preferred embodiments of this aspect of the invention may include one or more of the following additional features. The step of applying a binder material comprises applying by standard printing technology, e.g. by rotary screen roll or by gravure roll. The step of applying a binder material comprises applying the binder material with a pad. The method further comprises removing binder material in liquid state from interstitial spaces of the fabric body in a manner to control reduction of air permeability. The step of removing binder material comprises blowing air through the interstitial spaces or drawing air by suction through the interstitial spaces. The step of applying binder material comprises applying a binder material comprising a binder selected from the group consisting of acrylic, polyurethane, silicon and blends thereof, preferably in a form selected from the group consisting of resin, latex, polymer emulsion and polymer dispersion. The step of applying binder material comprises applying a binder material in a liquid carrier and allowing the liquid carrier to evaporate leaving the binder material or applying a binder material in a foam liquid carrier and allowing the foam carrier to collapse leaving the binder material. The step of applying the binder material comprises applying a binder material by engineered pattern printing technology to a fabric web. Preferably, the binder material is applied by engineered pattern printing techniques to form one or more first regions of enhanced surface durability by applying a first pattern with relatively greater density of binder or binder dots per unit area, e.g. to shoulder regions, and to form one or more second other regions of lesser surface durability by applying a second pattern with relatively lesser density of binder or binder dots per unit area, e.g. to body regions.

The invention thus provides a composite fabric article that overcomes the recognized deficiencies of fabrics of knit construction, discussed above, in particular when used in garments and other articles for harsher outdoor sports, without detracting significantly from qualities of the original form of the fabric found highly desirable for use during exercise or exertion, e.g., warmth, breathability, drapability, MVT, hand tactile, etc. Furthermore, improved fabric articles have a predetermined, controlled, i.e., limited, degree of air permeability may be formed according to the method of the invention.

The details of one or more embodiments of the invention are set forth in the accompanying drawings and the description below. Other features, objects, and advantages of the invention will be apparent from the description and drawings, and from the claims.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a somewhat diagrammatic view of an example of a fabric article, here, a jacket, of the invention, with an insulating layer of fleece on one or more regions of the inner surface and a non-continuous coating of binder material on one or more regions of the outer surface, for enhanced surface durability.

FIG. 2 is a somewhat diagrammatic plan view of the outer surface of a fabric article of the invention, with the binder material for enhanced surface durability against fraying and pilling adhered to yarns and yarns fibers about an interstitial space; and

FIG. 3 is a somewhat diagrammatic plan view of the outer surface of a fabric article of the invention, with the binder material for enhanced surface durability against fraying and pilling adhered to yarns and yarns fibers and also extending into interstitial spaces to increase wind resistance.

FIG. 4 is a plan view of a fabric web printed with a series of predetermined patterns of binder material applied by engineered pattern printing technology to form regions of enhanced surface durability; and

FIG. 5 is a plan view of a garment, here, a shirt, formed with elements cut from the fabric web of FIG. 4 and having enhanced surface durability regions at the shoulders.

Like reference symbols in the various drawings indicate like elements.

### DETAILED DESCRIPTION

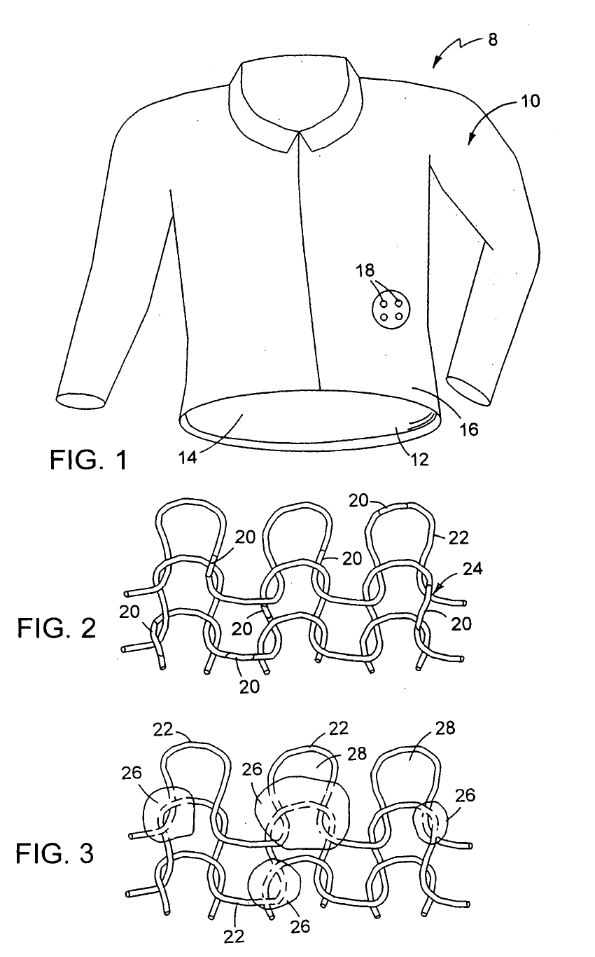

Referring to FIG. 1, a fabric article of wearing apparel 8, in this case, by way of example only, a jacket, is formed of an improved composite fabric 10 of the invention. The fabric has an inner surface 12, upon which is formed at least one insulating region fleece 14, and an outer surface 16, upon which is adhered a discontinuous coating 18 of binder or coagulant material, e.g. resin or latex, for enhanced surface durability, e.g. against pilling and fraying. Referring also to FIG. 2, in a preferred embodiment, regions 20 of binder or coagulant material are adhered primarily to yarn fibers 22 and at interlacing intersections of yarns 24, thereby allowing the fabric to retain its original form and characteristics, including good drapability and hand, and allowing through-passage of air to a predetermined degree (MVT and breathability), but also providing an outer surface of enhanced durability, e.g. against pilling and wear, e.g. during exercise and harsher outdoor sports.

Referring to FIG. 3, in other embodiments, as described more fully below, the binder material forms a film 26 that constricts (but preferably does not block) interstitial spaces 28 between yarns 22, thereby to reduce air-permeability and provide increased insulation and warmth, for use in particular under colder and windier conditions.

In a first example of a fabric article to be provided with an outer surface of enhanced durability according to the invention, the fabric has a plaited circular knit construction, e.g., as described in Knitting Technology, by David J. Spencer (Woodhead Publishing Limited, 2nd edition, 1996), the entire disclosure of which is incorporated herein by reference, with a smooth outer surface (technical face) and a raised inner surface (technical back). The stitch yarn forming the technical face is preferably a filament yarn of textured filaments formed of synthetic material, e.g. polyester, nylon or polypropylene, the yarn fibers or filaments having a high level of intermingling, e.g. at least over about 60 tucks per meter, and preferably over about 100 tucks per meter, to reduce the tendency of individual fibers to fray or catch and later on to pill. In preferred embodiments, the yarn has a fineness of 0.2 to 3.0 denier per filament (dpf); fraying is a particular concern in multi-fiber yarns, especially with yarns of fine dpf, e.g. 0.2 to 1.5.

In a second example of a fabric article to be provided with the outer surface of enhanced durability, the fabric has a reverse plaited circular knit construction, where the raised surface can be formed on the loop yarn, either on the loop side (technical back), which is preferred, or on the smooth side (technical face). The technical back can be any of a variety of constructions, e.g., knit and/or knit-tuck and/or knit-welt and/or knit-tuck-welt in a variety of combinations.

To avoid restricting or reducing the capability of maximizing the bulk of the raised or fleece surface at the technical back, the fabric articles of knit construction are preferably finished before application of the binder material to the outer surface.

In yet another example, the fabric has a woven construction of synthetic, multi-filament, textured yarn. Spandex is incorporated into the yarn, e.g. in air tuck, cover or core spun position, to provide the fabric with two-way or one-way stretch.

In still another example, the fabric upon which a surface of enhanced durability is to be formed has a warp knit construction, e.g. as described in my earlier U.S. Pat. Nos. 6,196,032, issued Mar. 6, 2001, and 6,199,410, issued Mar. 13, 2001, the complete disclosures of which are incorporated wherein by reference.

A fabric article, e.g. from the examples described above, is next treated to provide an outer surface of enhanced durability by applying binder material to reduce fiber fraying and minimize pilling.

In a preferred embodiment, a chemical binder material for forming a surface region of enhanced durability surface is applied to the smooth outer surface of the fabric article using standard printing technology, e.g. rotary or gravure roll. The binder is preferably applied in a non-continuous coating, e.g. a pattern of separate dots. Any suitable chemical binder material may be employed. Examples of such binders include resin (such melamine), latex (such as acrylate), polymer emulsions or dispersions (such as silicon), or polyurethane. The binder is preferably selected to have a dry hand upon curing or drying, i.e. not tacky to the touch good stretch/recovery, and good bond to textile fibers.

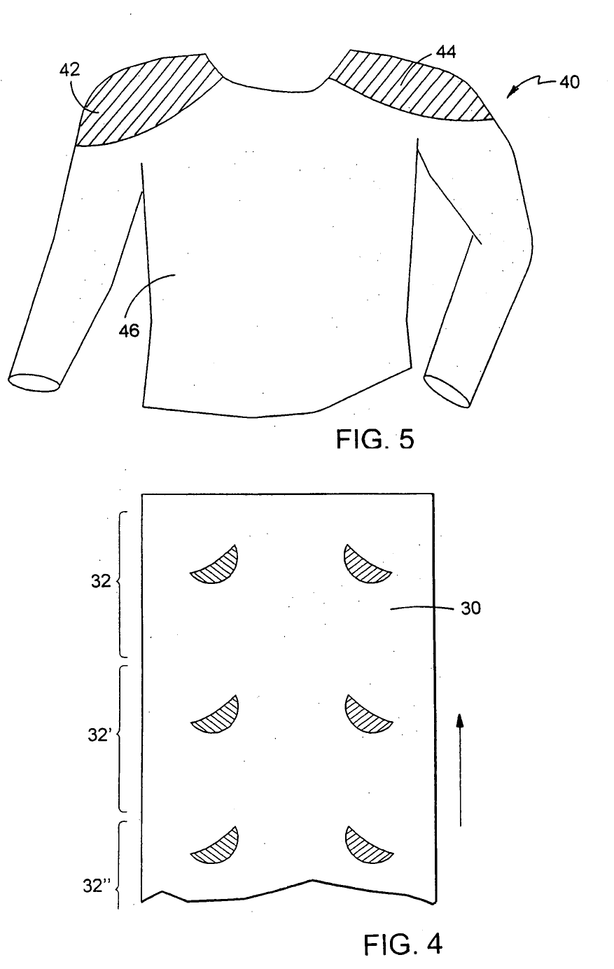

In another preferred embodiment, referring to FIGS. 4 and 5, a suitable binder material for forming a region of enhanced surface durability is applied by engineered pattern printing technology to a fabric web 30 (FIG. 4). For example, in FIG. 5, a shirt 40, formed with elements cut from fabric web 30, has surface regions 42, 44 of enhanced durability at the shoulders, which are more prone to abrasion and wear when carrying a backpack. Other regions of the shirt 40, e.g., the body region 46, may also be printed to provide enhanced surface durability. However, regions of less wear, e.g. such as the body region 46, may be printed in a different pattern with relatively less density of binder or binder dots per unit area.

Referring again to FIG. 4, the predetermined pattern of binder material is applied to the fabric web 30 in a series of shirt piece patterns 32, 32′, 32″ of predetermined configuration, using engineered pattern printing technology. In a later cut and sew process (not shown), the printed fabric web 30 is indexed through a cutter where shirt pieces are cut from the web and then subsequently sewn together in shirts 40.

In another embodiment, the binder for forming a surface region of enhanced durability surface is applied to the outer surface of the fabric article with a pad. In this embodiment, in order to reduce the tendency toward fraying while maintaining a high level of moisture vapor transmission, good drapability, hand and soft touch, deposit of the binder material is preferably limited primarily to the fibers and/or to the intersections of fibers in the yarn segments, and formation of binder film in the interstitial spaces between yarns is minimized. The formation of film may particularly be avoided by removal of excess liquid binder from interstitial spaces between yarns shortly following application, e.g. while the binder material is still wet or moist, by air suction or air blowing through the fabric article.

Preferably, the binder material is applied in a low viscosity system, or in a system with a relatively low level of binder solids or particulates in a liquid carrier, so that as the system dries, the liquid carrier evaporates (or in a foam system, collapses), leaving the solid binder deposited primarily or only on the yarns or yarn fibers. In this manner, the air permeability level and other characteristics of the base fabric are maintained.

In other embodiments, a binder material of relatively higher viscosity may be employed, to encourage formation of a fine film in the interstitial areas between yarns that will partially or fully maintain its integrity during the drying process. In this manner, the fabric article may be provided with increased water repellency and wind resistance, which would be advantageous in cold windy ambient environments. However, a full or continuous film is typically to be avoided, in order to maintain at least a minimum desired degree of moisture vapor transmission necessary for comfort during high energy activities, such as running, skiing, etc.

Referring again to FIG. 1, the garment 8 formed of the fabric article 10 of this embodiment of the invention thus has an outer surface 16 with a non-continuous binder coating 18 providing weather protection, with high pill resistance, high abrasion resistance, and pick resistance, and an inner surface 12 with a raised insulating region 14 with high bulk and softness. In particular embodiments, the fabric article may be provided with water repellence and wind protection.

The improved surface durability of fabric articles of the invention is demonstrated in a severe pilling and abrasion test, such as the modified Martindale abrasion test method of ASTM D 4966. According to this test method, a fabric article of the invention to be tested is subjected to repeated rubbing by a strip of the hook element (General Application type, ¾-inch by ½-inch) of a hook-and-loop type fastener element. After 250 rubs, the appearance of the fabric article of the invention has been seen to be markedly better, e.g., as compared to untreated fabric articles.

A number of embodiments of the invention have been described. Nevertheless, it will be understood that various modifications may be made without departing from the spirit and scope of the invention. For example, other aesthetic effects may be applied face side to back side, including, e.g., color differentiation and/or patterning on one or both surfaces, including three dimensional effects. As mentioned above, the fabric article may have one-way or two-way stretch, and/or the fabric may be constructed to provide a degree of stretch from any of a broad range, including from very low stretch (very stable) or high stretch or compression power stretch. The binder material may be applied in other fashions as appropriate, e.g. by kiss coating or froth foam application, preferably to the technical face after raising the technical back. In other applications, the binder material may also be deposited, e.g., by pad application, upon both surfaces of the fabric article, including, e.g., upon a raised or fleece surface. The multi-strand or multi-filament yarn may, e.g., have the form of staple fibers in spun yarn or filaments in continuous yarn, or the fabric may be constructed with a combination of spun yarn, staple fibers and continuous filament yarn. In addition to suction and blowing of air through the fabric article during drying, the degree of film formation may also be controlled, e.g., by crushing the coated fabric between nip rollers.

Also, referring again to FIGS. 4 and 5, in other embodiments, only selected regions, e.g., shoulders 42, 44 may be printed to provide enhanced surface durability, and other regions of the shirt 40, e.g. the body region 46, may be left untreated to be raised while printed regions 42, 44 remain flat, resisting the napping process.

Accordingly, other embodiments are within the scope of the following claims.

1. A fabric article of knitted or woven construction of multi-filament, interlaced yarns, the fabric article having an inner surface and an outer surface, the inner surface having at least one region of pile or raised fibers or fleece formed thereupon, and the outer surface having at least one region of a non-continuous coating of binder material adhered to yarns and to yarn fibers at least at interlacing intersections, for durability of the outer surface against pilling or fraying during use.

2. The fabric article of claim 1, wherein the fabric article has a plaited circular knit construction.

3. The fabric article of claim 1, wherein the fabric article has a reverse plaited circular knit construction.

4. The fabric article of claim 1, wherein the fabric article has a woven construction.

5. The fabric article of claim 1, wherein the fabric article has a warp knit construction.

6. The fabric article of claim 1 in the form of an article of wearing apparel.

7. The fabric article of claim 1, wherein the multi-filament yarns are textured.

8. The fabric article of claim 1, wherein the multi-filament yarns are flat.

9. The fabric article of claim 1, wherein the multi-filament yarns comprises fibers formed of materials selected from the group consisting of: polyester, nylon and polypropylene.

10. The fabric article of claim 1, wherein the multi-filament yarns of the outer surface comprise spandex.

11. The fabric article of claim 1, wherein fibers of the multi-filament yarns are highly intermingled at over about 60 tucks per meter.

12. The fabric article of claim 11, wherein fibers of the multi-filament yarns are highly intermingled at over about 100 tucks per meter.

13. The fabric article of claim 1, wherein fibers of the multi-filament yarns have little or no intermingling.

14. The fabric article of claim 1, wherein the binder material adheres only to yarn fibers in a manner to substantially avoid restriction of air permeability through the fabric article.

15. The fabric article of claim 1, wherein the binder material comprises a film extending into interstitial air passageways through the fabric article in a manner to reduce air permeability.

16. The fabric article of claim 1, wherein the at least one region of a non-continuous coating of binder material is without substantial adverse effect on drapability and hand of the fabric article.

17. The fabric article of claim 1, wherein the at least one region of a non-continuous coating of binder upon the outer surface of the fabric article comprises one or more first regions of enhanced surface durability due to relatively greater density of binder or binder dots per unit area applied by engineered pattern printing technology to a fabric web.

18. The fabric article of claim 17, wherein said one or more first regions comprises shoulder regions.

19. The fabric article of claim 1 or claim 17, wherein the outer surface of the fabric article further comprises one or more second regions of relatively lesser surface durability due to relatively lesser density of binder or binder dots per unit area applied by engineered pattern printing technology to a fabric web.

20. The fabric article of claim 19, wherein said one or more second regions comprises body regions.

21. A method of forming a fabric article, said method comprising the steps of:
interlacing yarns comprising multi-filament fibers to form a fabric body of knit or woven construction,
forming a raised or fleece region upon an inner surface of the fabric body; and, thereafter,
applying binder material to one or more regions of an outer surface of the fabric article to form a discontinuous coating of binder material upon at least yarn fibers at interlacing intersections on at least the outer surface of the fabric article, to resist pilling and fraying of yarn fibers at the outer surface.

22. The method of claim 21, wherein the step of applying binder material comprises applying binder material by standard printing technology.

23. The method of claim 22, wherein the standard printing technology comprises printing by rotary screen roll.

24. The method of claim 22, wherein the standard printing technology comprises printing by gravure roll.

25. The method of claim 21, wherein the step of applying binder material comprises applying the binder material with a pad.

26. The method of claim 21, further comprising removing binder material in liquid state from interstitial spaces of the fabric body in a manner to control reduction of air permeability.

27. The method of claim 26, wherein the step of removing binder material comprises blowing air through the interstitial spaces.

28. The method of claim 26, wherein the step of removing binder material comprises drawing air by suction through the interstitial spaces.

29. The method of claim 21, wherein the step of applying binder material comprises applying binder material comprising a binder selected from the group consisting of melamine, acrylate, polyurethane, and silicon.

30. The method of claim 29, wherein the binder is in a form selected from the group consisting of resin, latex, polymer emulsion and polymer dispersion.

31. The method of claim 21, wherein the step of applying binder material comprises applying binder material in a liquid carrier and allowing the liquid carrier to evaporate leaving the binder material.

32. The method of claim 21, wherein the step of applying binder material comprises applying binder material in a foam liquid carrier and allowing the foam carrier to collapse leaving the binder material.

33. The method of claim 21, wherein the fabric article is formed of a knit construction with a technical face defining the outer surface and a technical back defining the inner surface, and the method comprises raising the technical back and thereafter applying the binder material to the technical face.

34. The method of claim 21, wherein the step of applying binder material comprises applying binder material by engineered pattern printing technology to a fabric web.

35. The method of claim 34, wherein the step of applying binder material by engineered pattern printing technology to a fabric web comprises:
forming one or more first regions of enhanced surface durability by applying a first pattern with relatively greater density of binder or binder dots per unit area, and
forming one or more second other regions of relatively lesser surface durability by applying a second pattern with relatively lesser density of binder or binder dots per unit area.

36. The method of claim 35, wherein the step of forming one or more first regions of enhanced surface durability comprises applying the first pattern with relatively greater density of binder or binder dots per unit area at least upon shoulder regions.

37. The method of claim 35 or claim 36, wherein the step of forming one or more second other regions of relatively lesser surface durability comprises applying the second pattern with relatively lesser density of binder or binder dots per unit area at least upon body regions.

38. The fabric article of claim 19, wherein one or more of the second other regions of relatively lesser surface durability have no or only negligible density of binder or binder dots per unit area.

39. The fabric article of claim 38, wherein one or more of the second other regions of the outer surface comprises regions of pile or raised fibers or fleece and one or more of the first regions of the outer surface remains non raised or smooth face.

40. The fabric article of claim 39, wherein said one or more second other regions comprises body regions of the fabric article.

41. The method of claim 34, wherein the step of applying binder material by engineered printing technology to a fabric web comprises the steps of:
forming one or more first regions of enhanced surface durability by applying a first pattern with relatively greater density of binder or binder dots per unit area, and
forming one or more second other regions of relatively lesser surface durability by applying no or only negligible density of binder or binder dots per unit area.

42. The method of claim 41, wherein the step of forming one or more first regions of enhanced surface durability comprises applying the first pattern with relatively greater density of binder or binder dots per unit area at least upon shoulder regions.

43. The method of claim 41 or claim 42, wherein the step of forming one or more second other regions of relatively lesser surface durability comprises forming second other regions at least upon body regions.
